(19) United States
(12) Patent Application Publication
(10) Pub. No.: US 2016/0167024 A1
(43) Pub. Date: Jun. 16, 2016

(54) Synergized PGM Catalyst Systems Including Rhodium for TWC Application

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/572,200

(22) Filed: Dec. 16, 2014

(51) Int. Cl. B01J 23/889; B01J 35/04; B01J 23/46; B01D 53/94; B01J 21/04; B01J 21/00; B01D 53/86; B01J 35/00; B01J 23/20

(52) U.S. Cl. CPC B01J 23/8892; B01J 35/0006; B01J 35/04; B01J 23/464; B01J 23/20; B01J 21/04; B01J 21/005; B01D 53/865; B01D 53/945; B01D 2255/405; B01D 2255/40; B01D 2255/2092; B01D 2255/20715; B01D 2255/2073; B01D 2255/20761; B01D 2255/207; B01D 2255/1025

(57) ABSTRACT

Synergized Platinum Group Metals (SPGM) catalyst system for TWC application is disclosed. Disclosed SPGM catalyst system may include a washcoat that includes Cu—Mn spinel structure, supported on doped ZrO₂, and an overcoat that includes PGM, such as Rhodium (Rh) supported on carrier material oxides, such as alumina. SPGM catalyst system shows significant improvement in nitrogen oxide reduction performance under lean and also rich operating conditions. Furthermore, disclosed SPGM catalyst systems are found to have enhanced fresh and aged catalytic activity compared to PGM catalyst system, showing that there is a synergistic effect between PGM catalyst, such as Rh, and Cu—Mn spinel within disclosed SPGM catalyst system, which help in activity and thermal stability of disclosed SPGM catalyst.

### BACKGROUND

1. Technical Field

The present disclosure relates generally to PGM catalyst systems, and, more particularly, to synergized PGM catalyst systems.

N/A

2. Background Information

Catalysts in catalytic converters have been used to decrease the pollution caused by exhaust from various sources, such as automobiles, utility plants, processing and manufacturing plants, airplanes, trains, all-terrain vehicles, boats, mining equipment, and other engine-equipped machines. Important pollutants in the exhaust gas of internal combustion engines may include carbon monoxide (CO), unburned hydrocarbons (HC), nitrogen oxides (NOₓ), and particulate matter (PM). Several oxidation and reduction reactions take place in the catalytic converter, which is capable of removing the major pollutants HC, CO and NOₓ simultaneously, therefore, it is called a three-way catalyst.

Catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters. Additionally, engines associated with TWC using PGM operate at or near stoichiometric conditions.

Catalytic materials used in TWC applications have also changed, and the new materials have to be thermally stable under the fluctuating exhaust gas conditions. The attainment of the requirements regarding the techniques to monitor the degree of the catalyst's deterioration/deactivation demands highly active and thermally stable catalysts in which fewer constituents may be provided to reduce manufacturing costs, offer additional economic alternatives, and maintain high performance materials with optimal thermal stability and enhanced performance due to its facile nature of the redox function of the used chemical components.

For the foregoing reasons, there is a need for combined catalyst systems that include low amounts of PGM catalysts, which may have facile nature of the redox function of the used chemical components, and which may exhibit optimal synergistic behavior yielding enhanced activity and performance under both lean condition and rich condition.

### SUMMARY

The present disclosure provides Synergized Platinum Group Metals (SPGM) catalyst systems which may exhibit high catalytic activity, under lean condition or rich condition, and thus enhanced NO_{R}, and CO conversion compared to PGM catalyst systems.

According to an embodiment, SPGM catalyst system may include at least a substrate, a washcoat, and an overcoat, where substrate may include a ceramic material, washcoat may include a Cu—Mn spinel structure, CuₓMn₃₋ₓO₄, supported on doped-ZrO₂, and overcoat may include PGM catalyst, such as Rhodium (Rh) supported on carrier material oxides. Suitable carrier material oxides may be alumina.

In order to compare performance and determine synergism of Cu—Mn spinel structure with Rh catalyst, a PGM catalyst system without Cu—Mn spinel structure may be prepared, where PGM catalyst system may include a ceramic material, a washcoat that may include doped-ZrO₂, and an overcoat that may include a PGM catalyst, such as Rh supported on carrier material oxides. Suitable carrier material oxides may be alumina.

Disclosed SPGM catalyst system may be prepared using suitable known in the art synthesis method, such as co-milling process, and co-precipitation process, among others.

According to one aspect of the present disclosure, fresh and aged samples of disclosed SPGM catalyst system and of PGM catalyst system may be prepared, including very low amount of PGM such as about 1 g/ft³ of Rh in overcoat, in order to compare catalytic activity of disclosed SPGM catalyst system (including Cu—Mn spinel) with PGM catalyst systems (without Cu—Mn spinel).

Catalytic activity in fresh, hydrothermally aged (900° C. during about 4 hours), and fuel cut aged (at 800° C. during about 20 hours) samples of disclosed SPGM catalyst system and of PGM catalyst system may be determined by performing isothermal steady state sweep tests in a range of rich to lean conditions, and compared with results for disclosed SPGM catalyst system with PGM catalyst systems.

SPGM catalyst system of the present disclosure may show surprisingly significant improvement in nitrogen oxide conversion under stoichiometric operating conditions and especially under lean operating conditions which may allow reduced consumption of fuel. It has been shown that the enhanced catalytic activity is produced by the synergistic effect of Cu—Mn spinel on Rh (PGM catalyst). Furthermore, disclosed SPGM catalyst system that includes a Cu—Mn spinel may enable the use of a catalyst converter that includes low amounts of PGM.

Numerous other aspects, features and benefits of the present disclosure may be made apparent from the following detailed description taken together with the drawing figures.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows a SPGM catalyst system configuration including Cu—Mn spinel referred as SPGM catalyst system Type 1, according to an embodiment.

FIG. 2 illustrates a PGM catalyst system configuration with no Cu—Mn spinel referred as PGM catalyst system Type 2, according to an embodiment.

FIG. 3 depicts NOₓ conversion comparison for fresh samples of SPGM catalyst systems Type 1, and PGM catalyst system Type 2, under isothermal steady state sweep condition, at inlet temperature of about 450° C., and space velocity (SV) of about 40,000 h⁻¹, according to an embodiment.

FIG. 4 depicts NOₓ conversion comparison for hydrothermally aged samples (at 900° C. during about 4 hours) of SPGM catalyst systems Type 1 and PGM catalyst system Type 2, under isothermal steady state sweep condition, at inlet temperature of about 450° C., and SV of about 40,000 h⁻¹, according to an embodiment.

FIG. 5 depicts CO conversion comparison for hydrothermally aged samples (at 900° C. during about 4 hours) of SPGM catalyst systems Type 1 and PGM catalyst system Type 2 under isothermal steady state sweep condition, at inlet temperature of about 450° C., and SV of about 40,000 h⁻¹, according to an embodiment.

FIG. 6 depicts CO conversion comparison for fuel cut aged samples (at 800° C. during about 20 hours) of SPGM catalyst systems Type 1 and PGM catalyst system Type 2, under isothermal steady state sweep condition, at inlet temperature of about 450° C., and SV of about 40,000 h⁻¹, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used here, the following terms may have the following definitions:

“Catalyst system” refers to a system of at least two layers including at least one substrate, a washcoat, and/or an overcoat.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat layer.

“Catalyst” refers to one or more materials that may be of use in the conversion of one or more other materials.

“Milling” refers to the operation of breaking a solid material into a desired grain or particle size.

“Co-precipitation” refers to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Platinum group metals (PGM)” refers to platinum, palladium, ruthenium, iridium, osmium, and rhodium.

“Synergized platinum group metal (SPGM) catalyst” refers to a PGM catalyst system which is synergized by a non-PGM group metal compound under different configuration.

“Zero Platinum group metals (ZPGM)” refers to catalyst system that is free of PGM.

“Treating,” “treated,” or “treatment” refers to drying, firing, heating, evaporating, calcining, or mixtures thereof.

“Three-Way Catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“R-Value” refers to the number obtained by dividing the reducing potential by the oxidizing potential.

“Lean condition” refers to exhaust gas condition with an R-value below 1.

“Rich condition” refers to exhaust gas condition with an R value above 1.

“Stoichiometric condition” refers to the condition when the oxygen of the combustion gas or air added equals the amount for completely combusting the fuel.

“Conversion” refers to the chemical alteration of at least one material into one or more other materials.

“Spinel” refers to any of various mineral oxides of magnesium, iron, zinc, or manganese in combination with aluminum, chromium, copper or iron with AB₂O₄ structure.

### DESCRIPTION OF THE DRAWINGS

The present disclosure may provide a synergized PGM (SPGM) catalyst system which may have enhanced catalytic performance of PGM catalyst under lean condition or rich condition, by incorporating more active components into phase materials possessing three-way catalyst (TWC) properties.

Embodiments of the present disclosure provide catalyst performance comparison of disclosed SPGM catalyst system and a PGM catalyst system that may include Rhodium (Rh) within the overcoat of disclosed SPGM catalyst systems, and within the PGM catalyst system.

According to embodiments in the present disclosure, SPGM catalyst systems may be configured with a washcoat including Cu—Mn stoichiometric spinel with doped ZrO₂ support oxide such as Niobium-Zirconia support oxide, an overcoat including a PGM catalyst, such as Rh with alumina-based support, and suitable ceramic substrate, here referred as SPGM catalyst system Type 1. According to embodiments in the present disclosure, PGM catalyst systems may be configured with washcoat layer including doped ZrO2 support oxide such as Niobium-Zirconia support oxide, an overcoat including PGM catalyst, such as Rh with alumina-based support, and suitable ceramic substrate, here referred as PGM catalyst system Type 2.

Catalyst System Configuration

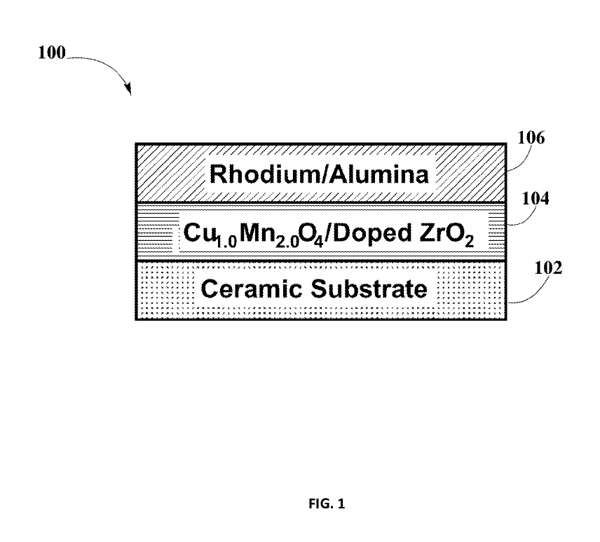

FIG. 1 shows a SPGM catalyst system configuration referred as SPGM catalyst system Type 1 100, according to an embodiment.

As shown in FIG. 1, SPGM catalyst system Type 1 100 may include at least a substrate 102, a washcoat 104, and an overcoat 106, where washcoat 104 may include a stoichiometric Cu—Mn spinel structure, Cu_{1.0}Mn_{2.0}O₄, supported on doped ZrO₂ and overcoat 106 may include PGM catalyst, such as Rh supported on carrier material oxides, such as alumina.

In an embodiment, substrate 102 materials for SPGM catalyst system Type 1 100 may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art. According to the present disclosure, preferred substrate 102 materials may be ceramic material.

According to an embodiment, washcoat 104 for SPGM catalyst system Type 1 100 may include a Cu—Mn stoichiometric spinel, Cu₁₀Mn₂₀O₄, as non PGM metal catalyst. Additionally, washcoat 104 may include support oxide such as zirconium oxide, doped zirconia. According to the present disclosure, suitable material for disclosed washcoat 104 may be Nb₂O₅—ZrO₂.

According to embodiments of the present disclosure, overcoat 106 for SPGM catalyst system Type 1 100 may include aluminum oxide, doped aluminum oxide, zirconium oxide, doped zirconia, titanium oxide, tin oxide, silicon dioxide, zeolite, and mixtures thereof. According to the present disclosure, most suitable material for disclosed overcoat 106 may be alumina (Al₂O₃). Additionally, overcoat 106 for SPGM catalyst system Type 1 100 may include a PGM catalyst, such as Palladium (Pd), Platinum (Pt), and Rhodium (Rh), among others. According to the present disclosure, PGM for disclosed overcoat 106 may be Rh.

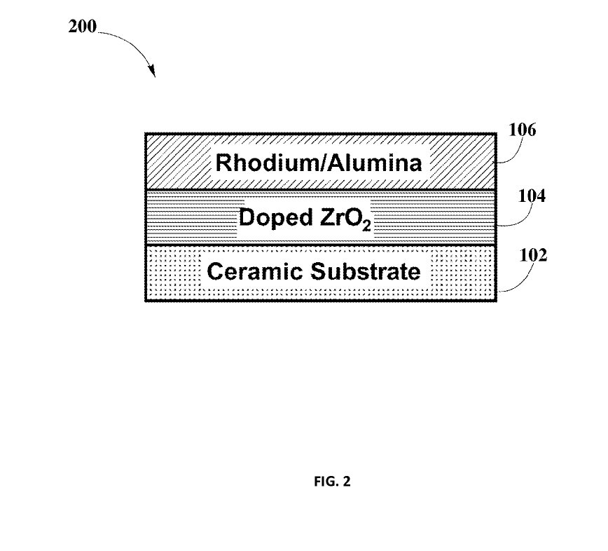

FIG. 2 illustrates a PGM catalyst system configuration referred as PGM catalyst system Type 2 200, according to an embodiment.

As shown in FIG. 2, PGM catalyst system Type 2 200 may include at least a substrate 102, a washcoat 104, and an overcoat 106, where washcoat 104 may include doped ZrO₂ and overcoat 106 may include carrier material oxides, such as alumina mixed with a PGM catalyst, such as Rh.

In an embodiment, substrate 102 materials for PGM catalyst system Type 2 200 may include a refractive material, a ceramic material, a honeycomb structure, a metallic material, a ceramic foam, a metallic foam, a reticulated foam, or suitable combinations. According to the present disclosure, preferred substrate 102 materials may be ceramic material.

According to an embodiment, washcoat 104 for PGM catalyst system Type 2 200 may include support oxide such as zirconium oxide, doped zirconia. According to the present disclosure, suitable material for disclosed washcoat 104 may be Nb₂O₅—ZrO₂.

According to embodiments of the present disclosure, overcoat 106 for PGM catalyst system Type 2 200 may include aluminum oxide, doped aluminum oxide, zirconium oxide, doped zirconia, titanium oxide, tin oxide, silicon dioxide, zeolite, and mixtures thereof. According to the present disclosure, most suitable material for disclosed overcoat 106 may be alumina (Al₂O₃). Additionally, overcoat 106 for PGM catalyst system Type 2 200 may include a PGM catalyst, such as Rh.

According to embodiments of the present disclosure PGM catalyst system Type 2 200 has the same configuration as SPGM catalyst system Type 1 100 in which Cu—Mn spinel is removed from washcoat 104, in order to demonstrate the effect of addition of Cu—Mn spinel to PGM catalyst system Type 2 200.

Preparation of SPGM Catalyst System Type 1 (With Cu—Mn Spinel)

The preparation of washcoat 104 may begin by co-milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing for about 1 to 2 hours, an appropriate amount of Mn nitrate solution and Cu nitrate solution. Subsequently, Cu—Mn nitrate solution may be mixed with Nb₂O₅—ZrO₂ support oxide slurry for about 2 to 4 hours, where Cu—Mn nitrate solution may be precipitated on Nb₂O₅—ZrO₂ support oxide aqueous slurry. A suitable base solution may be added, such as sodium hydroxide (NaOH) solution, sodium carbonate (Na₂CO₃) solution, ammonium hydroxide (NH₄OH) solution, tetraethyl ammonium hydroxide (TEAH) solution, (NH₄)₂CO₃, other tetraalkylammonium salts, ammonium acetate, or ammonium citrate, amongst others, to adjust pH at desired level. The precipitated Cu—Mn/Nb₂O₅—ZrO₂ slurry may be aged for a period of time of about 12 to 24 hours under continued stirring at room temperature.

Subsequently, the precipitated slurry may be coated on substrate 102. The aqueous slurry of Cu—Mn/Nb₂O₅—ZrO₂ may be deposited on the suitable ceramic substrate 102 to form washcoat 104, employing vacuum dosing and coating systems. In the present disclosure, a plurality of capacities of washcoat 104 loadings may be coated on the suitable ceramic substrate 102. The plurality of washcoat 104 loading may vary from about 60 g/L to about 200 g/L, in the present disclosure particularly about 120 g/L. Subsequently, after deposition on ceramic substrate 102 of the suitable loadings of Cu—Mn/Nb₂O₅—ZrO₂ slurry, washcoat 104 may be dried overnight at about 120° C. and subsequently calcined at a suitable temperature within a range of about 550° C. to about 650° C., preferably at about 600° C. for about 5 hours. Treatment of washcoat 104 may be enabled employing suitable drying and heating processes. A commercially-available air knife drying systems may be employed for drying washcoat 104. Heat treatments (calcination) may be performed using commercially-available firing (furnace) systems.

Overcoat 106 may include a combination of Rh on alumina-based support. The preparation of overcoat 106 may begin by milling the alumina-based support oxide separately to make aqueous slurry. Subsequently, a solution of Rh nitrate may be mixed with the aqueous slurry of alumina with a loading within a range from about 0.5 g/ft³ to about 10 g/ft³. According to the present disclosure, suitable loading of Rh for disclosed SPGM Catalyst System Type 1 100 may be 1 g/ft³. Total loading of washcoat 104 material may be 120 g/L. After mixing of Rh and alumina slurry, Rh may be locked down with an appropriate amount of one or more base solutions, such as sodium hydroxide (NaOH) solution, sodium carbonate (Na₂CO₃) solution, ammonium hydroxide (NH₄OH) solution, tetraethyl ammonium hydroxide (TEAH) solution, among others. In the present embodiment, Rh may be locked down using a base solution of tetraethyl ammonium hydroxide (TEAH). No pH adjustment is required. Then, the resulting slurry may be aged from about 12 hours to about 24 hours for subsequent coating as overcoat 106 on washcoat 104, dried and fired at about 550° C. for about 4 hours.

Preparation of PGM Catalyst System Type 2 (Without Cu—Mn Spinel)

The preparation of washcoat 104 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

Subsequently, washcoat 104 slurry may be coated on substrate 102. The washcoat 104 slurry may be deposited on the suitable ceramic substrate 102 to form washcoat 104, employing vacuum dosing and coating systems. In the present disclosure, a plurality of capacities of washcoat 104 loadings may be coated on suitable ceramic substrate 102. The plurality of washcoat 104 loading may vary from about 60 g/L to about 200 g/L, in the present disclosure particularly about 120 g/L. Washcoat 104 may be dried overnight at about 120° C. and subsequently calcined at a suitable temperature within a range of about 550° C. to about 650° C., preferably at about 550° C. for about 4 hours. Treatment of washcoat 104 may be enabled employing suitable drying and heating processes. A commercially-available air knife drying systems may be employed for drying washcoat 104. Heat treatments (calcination) may be performed using commercially-available firing (furnace) systems.

Overcoat 106 may include a combination of Rh on alumina-based support. The preparation of overcoat 106 may begin by milling the alumina-based support oxide separately to make aqueous slurry. Subsequently, a solution of Rh nitrate may be mixed with the aqueous slurry of alumina with a loading within a range from about 0.5 g/ft³ to about 10 g/ft³. According to the present disclosure, suitable loading of Rh for disclosed SPGM Catalyst System Type 1 100 may be 1 g/ft³. Total loading of washcoat 104 material may be 120 g/L. After mixing of Rh and alumina slurry, Rh may be locked down with an appropriate amount of one or more base solutions, such as sodium hydroxide (NaOH) solution, sodium carbonate (Na₂CO₃) solution, ammonium hydroxide (NH₄OH) solution, tetraethyl ammonium hydroxide (TEAH) solution, among others. Then, the resulting slurry may be aged from about 12 hours to about 24 hours for subsequent coating as overcoat 106 on washcoat 104, dried and fired at about 550° C. for about 4 hours.

Catalytic performance, for SPGM Catalyst System Type 1 100 and PGM catalyst system Type 2 200 may be compared by preparing fresh and aged samples for each of the catalyst formulations and configurations in present disclosure to show the synergistic effect of adding Cu—Mn spinel to PGM catalyst materials which may be used in TWC applications.

In order to compare TWC performance of disclosed SPGM catalyst system Type 1 100 and PGM catalyst system Type 2 200, isothermal steady state sweep tests may be performed.

Additionally, in order to determine effect of Rh loadings on synergistic effect of Cu—Mn within SPGM Catalyst System Type 1 100, samples of SPGM Catalyst System Type 1 100 and PGM catalyst system Type 2 200 with different Rh loadings may be prepared, and isothermal steady state sweep tests may be performed.

Isothermal Steady State Sweep Test Procedure

The isothermal steady state sweep test may be carried out employing a flow reactor in which the inlet temperature may be increased to about 450° C., and testing a gas stream at 11-point R-values from about 2.0 (rich condition) to about 0.80 (lean condition) to measure the CO, NOₓ, and HC conversions.

The space velocity (SV) in the flow reactor may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NO_{R}, about 2,000 ppm of H₂, 10% of CO₂, and 10% of H₂O. The quantity of O₂ in the gas mix may be varied to adjust R-value which is representative of Air/Fuel (A/F) ratio and to represent the three-way condition of the control loop.

NOx Conversion Comparison of SPGM Catalyst System Type 1 and PGM Catalyst System Type 2

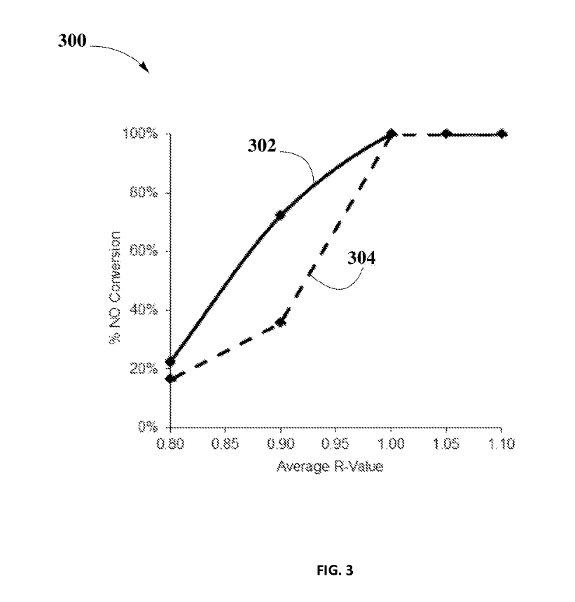

FIG. 3 depicts NOx conversion comparison 300 for fresh samples of SPGM catalyst system Type 1 100 and fresh samples of PGM catalyst system Type 2 200, under isothermal steady state sweep condition, at inlet temperature of about 450° C. and SV of about 40,000 h⁻¹, according to an embodiment.

As shown in FIG. 3, NOx conversion curve 302 (solid line) depicts performance of SPGM catalyst system Type 1 100, and NO conversion curve 304 (dashed line) illustrates performance of PGM catalyst system Type 2 200, under isothermal steady state sweep condition.

As may be observed in NOx conversion comparison 300, disclosed SPGM catalyst system Type 1 100 may perform better than disclosed PGM catalyst system Type 2 200, because of their improved NOx conversion under lean condition. For example, as shown in FIG. 3, at lean condition, R-value of about 0.9, while SPGM catalyst system Type 1 100 shows NOₓ conversion of about 72.3%, PGM catalyst system Type 2 200 shows NOₓ conversion of about 35.4%.

As may be observed in lean NOx conversion comparison 300, for fresh samples, there is an improved performance in NOₓ conversion for disclosed SPGM catalyst system Type 1 100, under lean condition, as compared to PGM catalyst system Type 2 200. This improved performance is the result of the synergistic effect between Rh, and the Cu—Mn spinel components in the respective composition of SPGM catalyst system Type 1 100, in which adding of Cu—Mn spinel components is responsible for the improved performance of NOₓ conversion under lean condition compared with the level of NOₓ conversion of PGM catalyst system Type 2 200 shown in NOx conversion comparison 300.

Both fresh samples of SPGM catalyst system Type 1 100 and of PGM catalyst system Type 2 200 present NOₓ conversion of about 100% at R-value of about 1.00, which is the stoichiometric R-value for PGM catalysts, showing high activity of disclosed fresh SPGM and fresh PGM catalyst systems.

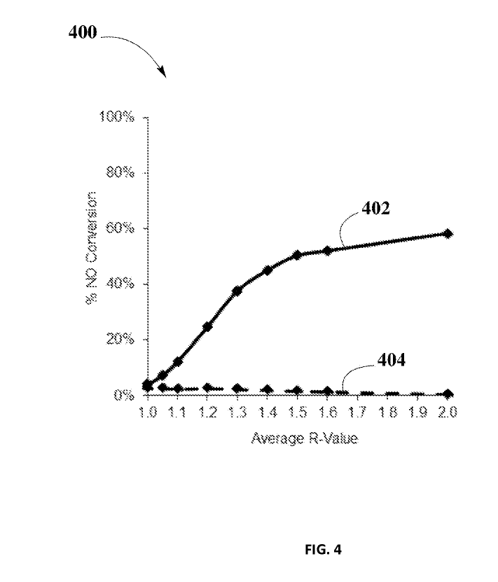

FIG. 4 depicts NOx conversion comparison 400 for hydrothermally aged samples (aged at 900° C. during about 4 hours) of SPGM catalyst system Type 1 100; and PGM catalyst system Type 2 200, under isothermal steady state sweep condition, at inlet temperature of about 450° C. and SV of about 40,000 h⁻¹, according to an embodiment.

In FIG. 4, NOx conversion curve 402 (solid line) shows performance of SPGM catalyst system Type 1 100, NOx conversion curve 404 (dashed line) depicts performance of PGM catalyst system Type 2 200, under isothermal steady state sweep condition.

As may be observed in NOx conversion comparison 400, disclosed SPGM catalyst system Type 1 100 after hydrothermal aging may perform better than disclosed PGM catalyst system Type 2 200 after same hydrothermal aging, because of their improved NOx conversion under rich condition. For example, as shown in FIG. 4, at all R-values region PGM catalyst system Type 2 200 shows no activity on NOₓ conversion, this is because Rh catalyst may be passivated by aging treatment (at 900° C. during about 4 hours). Moreover, SPGM catalyst system Type 1 100 shows catalytic activity of about 58.4% at fully rich condition, R-value of about 2.0. Since Rh may be passivated by the aging treatment (at 900° C. during about 4 hours), the catalytic activity of aged SPGM catalyst system Type 1 100 may be achieved only by the Cu—Mn spinel components in the composition of SPGM catalyst system Type 1 100.

As may be observed in rich NOx conversion comparison 400, for hydrothermally aged samples (aged at 900° C. during about 4 hours), there is an improved performance in NOₓ conversion for disclosed SPGM catalyst system Type 1 100, under rich condition, as compared to PGM catalyst system Type 2 200. This improved performance is the result of the synergistic effect of Cu—Mn spinel components in the respective composition of SPGM catalyst system Type 1 100, in which adding of Cu—Mn spinel components is responsible for the performance of NOₓ conversion under rich condition compared with no NOₓ conversion of PGM catalyst system Type 2 200 shown in NOx conversion comparison 400.

In addition, samples of aged (at 900° C. during about 4 hours) SPGM catalyst system Type 1 100 present greater NO conversion compared to PGM catalysts, showing thermal stability of disclosed aged (at 900° C. during about 4 hours) SPGM catalyst systems.

CO Conversion Comparison of SPGM Catalyst System Type 1 and PGM Catalyst System Type 2

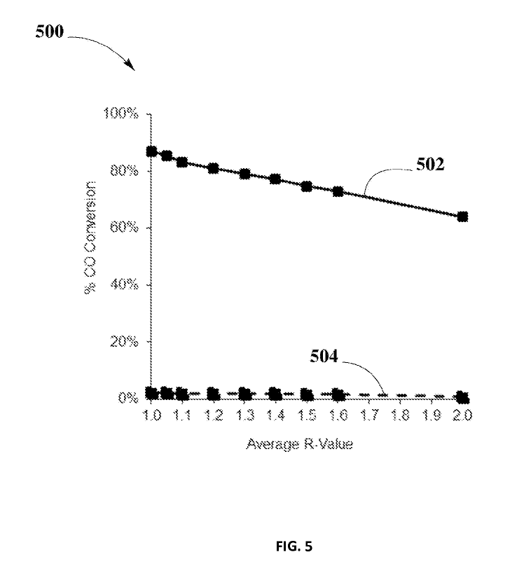

FIG. 5 depicts CO conversion comparison 500 in NOₓ conversion for hydrothermally aged samples (at 900° C. during about 4 hours) of SPGM catalyst system Type 1 100, and PGM catalyst system Type 2 200, under isothermal steady state sweep condition, at inlet temperature of about 450° C. and SV of about 40,000 h⁻¹, according to an embodiment.

In FIG. 5, CO conversion curve 502 (solid line) shows performance of SPGM catalyst system Type 1 100, CO conversion curve 504 (dashed line) depicts performance of PGM catalyst system Type 2 200, under isothermal steady state sweep condition.

As may be observed in CO conversion comparison 500, disclosed SPGM catalyst system Type 1 100 after hydrothermal aging, may perform better than disclosed PGM catalyst system Type 2 200 after same hydrothermal aging, because of their improved CO conversion under rich condition. For example, as shown in FIG. 5, at all R-values region PGM catalyst system Type 2 200 shows no activity on CO conversion, this is because Rh catalyst may be passivated by aging treatment (at 900° C. during about 4 hours). Moreover, SPGM catalyst system Type 1 100 shows catalytic activity of about 87% at stoichiometric R value (R=1.0) and about 72.9% at R value of about 1.6 at rich condition. Since Rh may be passivated by the aging treatment (at 900° C. during about 4 hours), the catalytic activity of aged SPGM catalyst system Type 1 100 may be achieved only by the Cu—Mn spinel components in the composition of SPGM catalyst system Type 1 100.

In addition, samples of aged (at 900° C. during about 4 hours) SPGM catalyst system Type 1 100 present greater CO conversion compared to PGM catalysts, showing thermal stability of disclosed aged (at 900° C. during about 4 hours) SPGM catalyst systems.

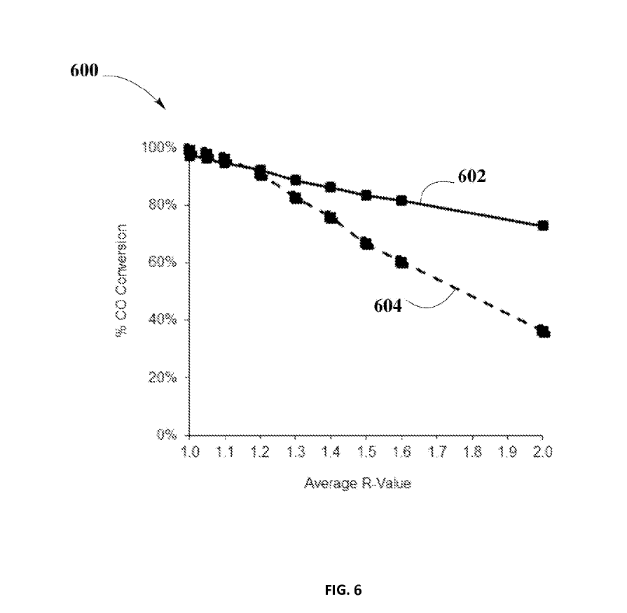

FIG. 6 depicts CO conversion comparison 600 in CO conversion for fuel cut aged samples (aged at 800° C. during about 20 hours) of SPGM catalyst system Type 1 100, and PGM catalyst system Type 2 200, under isothermal steady state sweep condition, at inlet temperature of about 450° C. and SV of about 40,000 h⁻¹, according to an embodiment.

In FIG. 6, CO conversion curve 602 (solid line) shows performance of SPGM catalyst system Type 1 100, CO conversion curve 604 (dashed line) depicts performance of PGM catalyst system Type 2 200, under isothermal steady state sweep condition.

As may be observed in CO conversion comparison 600, there is an improved performance in CO conversion for SPGM catalyst system Type 1 100 after fuel cut aging as compared to PGM catalyst system Type 2 200 after same fuel cut aging. This improved performance is the result of the synergistic effect between the PGM components, such as Rh, and the Cu—Mn spinel components in the respective composition of SPGM catalyst system Type 1 100, in which adding of Cu—Mn spinel components is responsible for the improved performance of CO conversion under rich condition compared with the level of CO conversion of PGM catalyst system Type 2 200 shown in CO conversion comparison 600. SPGM catalyst system Type 1 100 after fuel cut aging, may perform better than PGM catalyst system Type 2 200 after same fuel cut aging, because of their improved CO conversion under rich condition. For example, as shown in FIG. 3, at R-value of about 2.0 (rich condition), while SPGM catalyst system Type 1 100 shows NOₓ conversion of about 72.7%, PGM catalyst system Type 2 200 shows NOₓ conversion of about 36.4%.

SPGM catalyst system of the present disclosure, which is suitable for TWC application, may show significant improvement in nitrogen oxide conversion under lean operating conditions, in which synergistic effect between Rh and Cu—Mn spinel is responsible for such improvement. Furthermore, disclosed SPGM catalyst system that includes a Cu—Mn spinel may enable the use of a catalyst converter that includes very low amounts of PGM. Furthermore, synergistic effect of Cu—Mn on Rh results is improvement of CO conversion under both lean and rich condition. The improvement is more significant under rich condition. In addition, the significant improvement of NO and CO conversion under lean-rich condition of disclosed SPGM catalyst after hydrothermal and fuel cut aging shows thermal stability of disclosed SPGM catalyst systems, in which ZPGM component, Cu—Mn spinel, is responsible for such stability.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

1. A synergized platinum group metals (SPGM) catalyst system comprising:
a) an overcoat comprising a platinum group metal (PGM) catalyst comprising rhodium supported on a carrier material oxide;
b) a washcoat comprising a Cu—Mn spinel supported on a support oxide; and
c) a substrate.

2. The SPGM catalyst system of claim 1, wherein the substrate is ceramic.

3. The SPGM catalyst system of claim 1, wherein the carrier oxide material is selected from the group consisting of aluminum oxide, doped aluminum oxide, zirconium oxide, doped zirconia, titanium oxide, tin oxide, silicon dioxide, zeolite, and mixtures thereof.

4. The SPGM catalyst system of claim 1, wherein the carrier material oxide is aluminum oxide.

5. The SPGM catalyst system of claim 1, wherein the Cu—Mn spinel is according to the formula CuₓMn₃₋ₓO₄.

6. The SPGM catalyst system of claim 1, wherein the Cu—Mn spinel is CuMn₂O₄.

7. The SPGM catalyst system of claim 1, wherein the support oxide is a doped ZrO₂ support oxide.

8. The SPGM catalyst system of claim 1, wherein the doped ZrO₂ support oxide is a Niobium-zirconia support oxide.

9. The SPGM catalyst system of claim 1, wherein the rhodium is about 1 g/ft³ of rhodium.

10. The SPGM catalyst system of claim 1, wherein the SPGM catalyst system is hydrothermally aged.

11. The SPGM catalyst system of claim 10, wherein the hydrothermal aged system was heated at about 900° C. for about four hours.

12. The SPGM catalyst system of claim 1, wherein the SPGM catalyst system is fuel cut aged.

13. The SPGM catalyst system of claim 12, wherein the fuel cut aged system was heated at about 800° C. for about twenty hours.

14. The SPGM catalyst system of claim 2, wherein the ceramic is ceramic foam.

15. The SPGM catalyst system of claim 1, wherein the substrate is a honeycomb structure.

16. The SPGM catalyst system of claim 1, wherein the substrate is a foam.

17. The SPGM catalyst system of claim 16, wherein the foam is selected from the group consisting of a ceramic foam, a metallic foam, a reticulated foam, and combinations thereof.

18. The SPGM catalyst system of claim 1, wherein the substrate is a metallic material, refractive material, or a combination thereof.

19. The SPGM catalyst system of claim 1, wherein the PGM catalyst further comprises palladium, platinum, or the combination of palladium and platinum.

20. The SPGM catalyst system of claim 1, wherein the SPGM catalyst system a) reduces nitrogen oxide to nitrogen and oxygen, b) oxidizes carbon monoxide to carbon dioxide, and c) oxidizes unburnt hydrocarbons to carbon dioxide and water.

21. A synergized platinum group metals (SPGM) catalyst system comprising:
a) an overcoat comprising a platinum group metal (PGM) catalyst comprising rhodium supported on aluminum oxide;
b) a washcoat comprising a CuMn₂O₄ spinel supported on a doped ZrO₂ support oxide; and
c) a ceramic substrate.

22. A method of decreasing pollutants comprising applying exhaust to a synergized platinum group metals (SPGM) catalyst system comprising:
a) an overcoat comprising a platinum group metal (PGM) catalyst comprising rhodium supported on a carrier material oxide;
b) a washcoat comprising a Cu—Mn spinel supported on a support oxide; and
c) a substrate.

23. The method of claim 22, wherein the exhaust is from an engine-equipped machine.

24. The method of claim 22, wherein the engine-equipped machine is an automobile, airplane, train, all-terrain vehicle, boat, or mining equipment.

25. The method of claim 22, wherein the exhaust is from a utility plant, processing plant, or manufacturing plant.

26. The method of claim 22, wherein the SPGM catalyst system converts about 72% of nitrogen oxide.

27. The SPGM catalyst system of claim 22, wherein the substrate is ceramic.

28. The SPGM catalyst system of claim 22, wherein the carrier oxide material is selected from the group consisting of aluminum oxide, doped aluminum oxide, zirconium oxide, doped zirconia, titanium oxide, tin oxide, silicon dioxide, zeolite, and mixtures thereof.

29. The SPGM catalyst system of claim 22, wherein the carrier material oxide is aluminum oxide.

30. The SPGM catalyst system of claim 22, wherein the Cu—Mn spinel is according to the formula CuₓMn₃₋ₓO₄.

31. The SPGM catalyst system of claim 22, wherein the Cu—Mn spinel is CuMn₂O₄.

32. The SPGM catalyst system of claim 22, wherein the support oxide is a doped ZrO₂ support oxide.

33. The SPGM catalyst system of claim 22, wherein the doped ZrO₂ support oxide is a Niobium-zirconia support oxide.

34. The SPGM catalyst system of claim 22, wherein the rhodium is about 1 g/ft³ of rhodium.

35. The SPGM catalyst system of claim 22, wherein the SPGM catalyst system is hydrothermally aged.

36. The SPGM catalyst system of claim 35, wherein the hydrothermal aged system was heated at about 900° C. for about four hours.

37. The SPGM catalyst system of claim 22, wherein the SPGM catalyst system is fuel cut aged.

38. The SPGM catalyst system of claim 37, wherein the fuel cut aged system was heated at about 800° C. for about twenty hours.

39. The SPGM catalyst system of claim 23, wherein the ceramic is ceramic foam.

40. The SPGM catalyst system of claim 22, wherein the substrate is a honeycomb structure.

41. The SPGM catalyst system of claim 22, wherein the substrate is a foam.

42. The SPGM catalyst system of claim 41, wherein the foam is selected from the group consisting of a ceramic foam, a metallic foam, a reticulated foam, and combinations thereof.

43. The SPGM catalyst system of claim 22, wherein the substrate is a metallic material, refractive material, or a combination thereof.

44. The SPGM catalyst system of claim 22, wherein the PGM catalyst further comprises palladium, platinum, or the combination of palladium and platinum.

45. The SPGM catalyst system of claim 22, wherein the SPGM catalyst system a) reduces nitrogen oxide to nitrogen and oxygen, b) oxidizes carbon monoxide to carbon dioxide, and c) oxidizes unburnt hydrocarbons to carbon dioxide and water.
